(19) United States
(12) Patent Application Publication
(10) Pub. No.: US 2005/0120719 A1
(43) Pub. Date: Jun. 9, 2005

(54) Internally insulated turbine assembly

(76) Inventor: Andrew J. Olsen, Amesbury, MA (US)

Correspondence Address: MICHAEL BEST & FRIEDRICH, LLP, 100 E WISCONSIN AVENUE, MILWAUKEE, WI, 53202, US

(21) Appl. No.: 10/730,573

(22) Filed: Dec. 8, 2003

(51) Int. Cl. F02C 7/00

(52) U.S. Cl. 60/805

(57) ABSTRACT

A combustion turbine engine suited to operation in response to a flow of high-temperature gas. The combustion turbine engine generally includes an outer housing including walls that define an inlet, an outlet, and an inner surface. An insulation cartridge is disposed within the outer housing and defines an inner space. The insulation cartridge includes a wall and a core and is operable to at least partially thermally insulate the outer housing from the flow of high-temperature gas. A turbine rotor is disposed substantially within the inner space and is rotatable in response to the flow of high-temperature gas.

### BACKGROUND

The present invention relates to a turbine assembly for a combustion turbine engine. More particularly, the present invention relates an internally insulated turbine assembly for a microturbine engine.

Microturbine engines are relatively small and efficient sources of power. Microturbines can be used to generate electricity and/or to power auxiliary equipment such as pumps or compressors. When used to generate electricity, microturbines can be used independent of the utility grid or synchronized to the utility grid. In general, microturbine engines are limited to applications requiring 2 megawatts (MW) of power or less. However, some applications larger than 2 MWs may utilize a microturbine engine.

Many microturbine engines employ a thick-walled turbine casing manufactured from a high-temperature alloy (e.g., nickel-based alloys, stainless steel, Inconel, Hastelloy X, and the like). Even with the use of high-temperature alloys, the casing strength is reduced at normal operating temperatures, thus requiring the relatively thick casing wall. The thick wall allows the casing to contain the high-temperature high-pressure gas within the casing.

As applications that use microturbine engines grow in their output requirements, larger turbines will be required. Larger turbines require larger casings that will be exposed to additional forces generated by the pressure of the gas within the casing. In addition, larger casings increase the problems associated with thermal expansion, thereby requiring greater clearances between components, which can reduce engine efficiency. The larger casings also greatly increase the cost of the engine due to the cost of the alloys used to manufacture the casing.

### SUMMARY

The present invention provides a combustion turbine engine suited to operation in response to a flow of high-temperature gas. The combustion turbine engine generally includes an outer housing including walls that define an inlet, an outlet, and an inner surface. An insulation cartridge is disposed within the outer housing and defines an inner space. The insulation cartridge includes a wall and a core and is operable to at least partially thermally insulate the outer housing from the flow of high-temperature gas. A turbine rotor is disposed substantially within the inner space and is rotatable in response to the flow of high-temperature gas.

In another aspect, the invention generally provides a microturbine engine system operable to provide electrical power. The microturbine engine system includes a compressor that is operable to produce a flow of compressed air and a recuperator in fluid communication with the compressor to receive the flow of compressed air. The flow of compressed air is preheated within the recuperator to produce a flow of preheated compressed air. A combustor receives the flow of preheated compressed air and is operable to produce a flow of products of combustion. The flow of products of combustion have a temperature that generates thermal forces and a pressure that generates pressure forces. A turbine is driven by the flow of products of combustion. The turbine discharges the flow of products of combustion to the recuperator to preheat the flow of compressed air. A housing at least partially encloses the turbine and includes an inner surface. An insulation cartridge is positioned within the housing. The insulation cartridge at least partially isolates the housing from the flow of products of combustion such that the housing absorbs a majority of the pressure forces and the insulation cartridge absorbs a majority of the thermal forces. A generator is coupled to the turbine. The generator is driven by the turbine at a speed to output electrical power.

In yet another aspect, the present invention generally provides a method of assembling a turbine for use in a combustion turbine engine. The method includes providing a housing including an inlet, an outlet, and an inner surface and forming an insulation cartridge having a wall that defines a core space. The method also includes positioning an insulating material within the core space, inserting the insulation cartridge into the turbine casing, and supporting a rotor for rotation within the housing.

### BRIEF DESCRIPTION OF THE DRAWINGS

The description particularly refers to the accompanying figures in which:

FIG. 1 is a perspective view of a portion of a microturbine engine;

FIG. 2 is a sectional view of a portion of the microturbine engine of FIG. 1;

FIG. 3 is a perspective view of an insulation cartridge of FIG. 2; and

FIG. 4 is a perspective view of an outlet half of the insulation cartridge of FIG. 3.

Before any embodiments of the invention are explained, it is to be understood that the invention is not limited in its application to the details of construction and the arrangements of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof is meant to encompass the items listed thereafter and equivalence thereof as well as additional items. The terms “connected,” “coupled,” and “mounted” and variations thereof are used broadly and encompass direct and indirect connections, couplings, and mountings. In addition, the terms “connected,” “coupled,” and “mounted” and variations thereof are not restricted to physical or mechanical connections or couplings.

### DETAILED DESCRIPTION

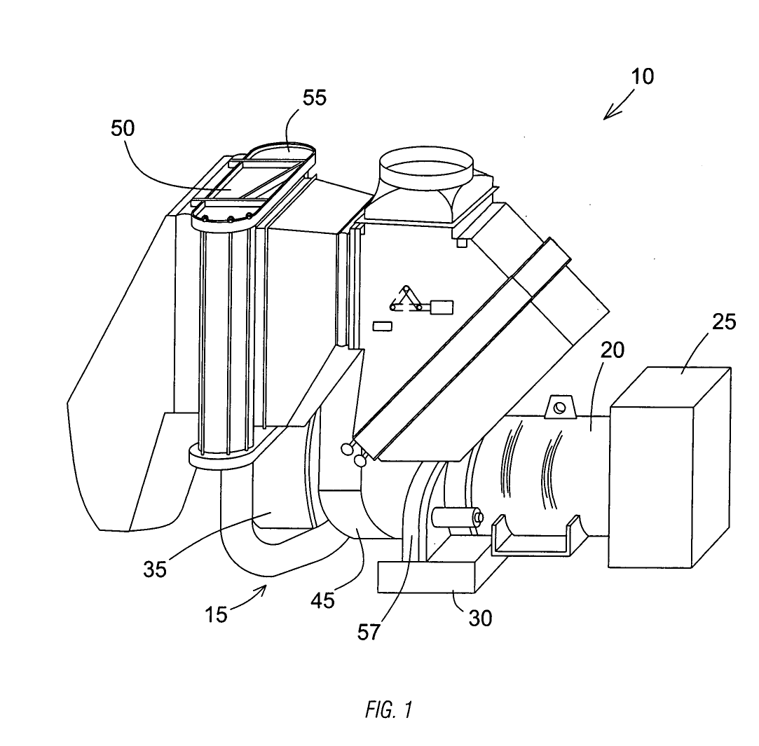

With reference to FIG. 1, a microturbine engine system 10 that includes a turbine section 15, a generator section 20, and a control system 25 is illustrated. The turbine section 15 includes a radial flow turbine 35, a compressor 45, a recuperator 50, and a combustor 55.

The engine 10 includes a standard Brayton cycle combustion turbine with the recuperator 50 added to improve engine efficiency. The engine shown is a single-spool engine (one set of rotating elements). However, multi-spool engines are also contemplated by the invention. The compressor 45 is a centrifugal-type compressor having a rotary element that rotates in response to operation of the turbine 35. The compressor 45 shown is a single-stage compressor. However, multi-stage compressors can be employed where a higher pressure ratio is desired. Alternatively, compressors of different designs (e.g., axial-flow compressors, reciprocating compressors, and the like) can be employed to supply compressed air to the engine.

The turbine 35 is a radial flow single-stage turbine having a rotary element directly coupled to the rotary element of the compressor 45. In other constructions, multi-stage turbines or other types of turbines may be employed. The coupled rotary elements of the turbine 35 and the compressor 45 engage a gearbox 57 or other speed reducer disposed between the turbine section 15 and the generator section 20. In other constructions, the coupled rotary elements engage the generator section 20 directly.

The recuperator 50 includes a heat exchanger employed to transfer heat from a hot fluid to the relatively cool compressed air leaving the compressor 45. One suitable recuperator 50 is described in U.S. Pat. No. 5,983,992 fully incorporated herein by reference. The recuperator 50 includes a plurality of heat exchange cells stacked on top of one another to define flow paths therebetween. The cool compressed air flows within the individual cells, while a flow of hot exhaust gas passes between the heat exchange cells.

During operation of the microturbine engine system 10, the rotary element of the compressor 45 rotates in response to rotation of the rotary element of the turbine 35. The compressor 45 draws in atmospheric air and increases its pressure. The high-pressure air exits the air compressor 45 and flows to the recuperator 50.

The flow of compressed air, now preheated within the recuperator 50, flows to the combustor as a flow of preheated air. The preheated air mixes with a supply of fuel within the combustor 55 and is combusted to produce a flow of products of combustion. The use of the recuperator 50 to preheat the air allows for the use of less fuel to reach the desired temperature within the flow of products of combustion, thereby improving engine efficiency.

The flow of products of combustion enters the turbine 35 and transfers thermal and kinetic energy to the turbine 35. The energy transfer results in rotation of the rotary element of the turbine 35 and a drop in the temperature of the products of combustion. The energy transfer allows the turbine 35 to drive both the compressor 45 and the generator 20. The products of combustion exit the turbine 35 as a first exhaust gas flow.

In constructions that employ a second turbine, the first turbine 35 drives only the compressor, while the second turbine drives the generator 20 or any other device to be driven. The second turbine receives the first exhaust flow, rotates in response to the flow of exhaust gas therethrough, and discharges a second exhaust flow.

The first exhaust flow, or second exhaust flow in two turbine engines, enters the flow areas between the heat exchange cells of the recuperator 50 and transfers excess heat energy to the flow of compressed air. The exhaust gas then exits the recuperator 50 and is discharged to the atmosphere, processed, or further used as desired (e.g., cogeneration using a second heat exchanger).

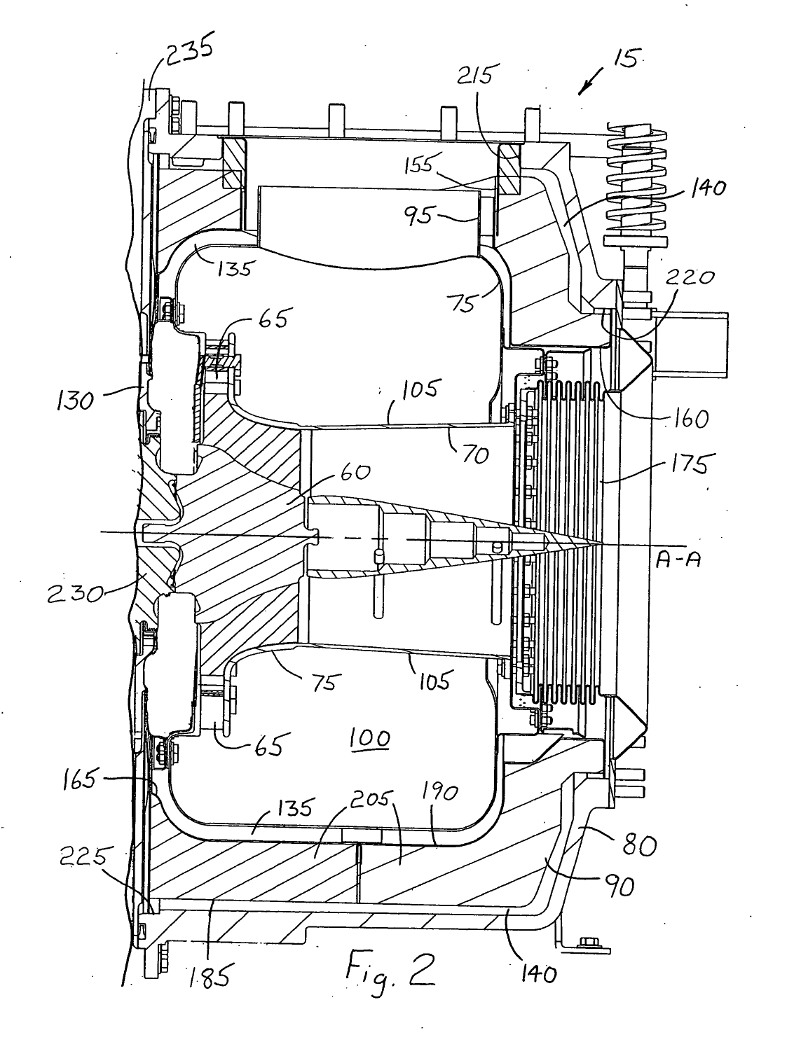

FIG. 2 illustrates the turbine section 15 including a turbine rotor 60, inlet guide vanes 65, a shroud/diffuser 70, a scroll case 75, an outer casing 80, and an insulation cartridge 90. The turbine rotor 60 includes a plurality of vanes that rotate with the rotor 60 and are arranged to provide for efficient expansion of the flow of products of combustion. The flow of products of combustion enters the turbine rotor 60 in a substantially radial direction and exits the turbine rotor 60 in a substantially axial direction parallel to the rotational axis A-A of the turbine rotor 60. The products of combustion then exit the turbine section 15 through the shroud/diffuser 70. In some constructions, an additional diffuser attaches to the turbine section 15 to further decelerate the flow exiting the turbine rotor 60.

The inlet guide vanes 65 are positioned between the turbine scroll 75 and the shroud/diffuser 70. The inlet guide vanes 65 are positioned to direct and accelerate the flow of products of combustion along the desired vector as the flow of products of combustion enters the turbine rotor 60.

The turbine scroll 75 is positioned as the inner most casing of the turbine section 15 and contains the flow of products of combustion as the flow enters the turbine section 15. The flow enters the turbine scroll 75 through an inlet 95 and fills an annular chamber 100 defined by the scroll 75. From the annular chamber 100, the flow passes through the inlet guide vanes 65 to the turbine rotor 60. The innermost wall 105 of the turbine shroud/diffuser 70 follows the outer contour of the turbine rotor 60 and functions to contain the flow of products of combustion within the turbine rotor 60. The innermost wall 105 also forms a portion of, or attaches to, the shroud/diffuser 70 and cooperates with the scroll 75 to completely enclose the annular chamber 100 and define an outer flow path wall for the flow passing through the turbine rotor 60 and the shroud/diffuser 70.

The turbine scroll 75 is generally formed from a thin-walled metal material (e.g., nickel-based alloys, stainless steel, Inconel, Hastelloy X, and the like). The thin wall of the scroll 75 allows it to move and flex in response to temperature changes. In addition, the thin wall is able to quickly and uniformly change temperature in response to temperature changes of its surrounding, thereby reducing the overall thermal stress applied to or built up within the turbine scroll 75.

The insulation cartridge 90 is positioned between the turbine scroll 75 and the outer casing 80 and as such defines an inner gap 135 between the insulation cartridge 90 and the turbine scroll 75 and an outer gap 140 between the insulation cartridge 90 and the outer casing 80.

The insulation cartridge 90 is generally manufactured from thin metal materials (e.g., less than about 0.2 inches and preferably less than about ⅛ of an inch) that react quickly and evenly to temperature changes. However, like the turbine scroll 75, the insulation cartridge 90 is exposed to high-temperature gas. As such, an appropriate high-temperature material (e.g., nickel-based alloys, stainless steel, Inconel, Hastelloy X, and the like) should be used to form the insulation cartridge 90.

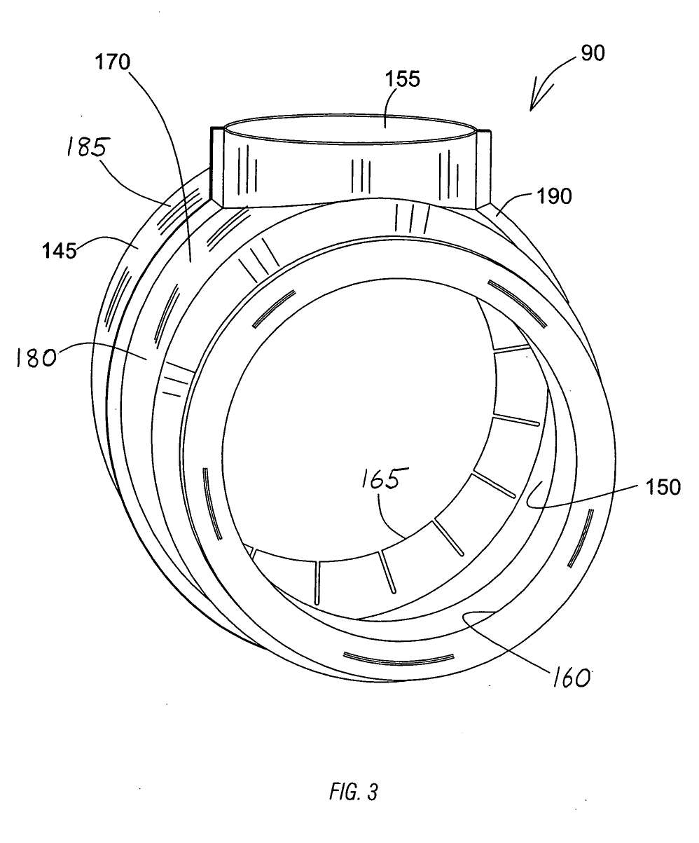

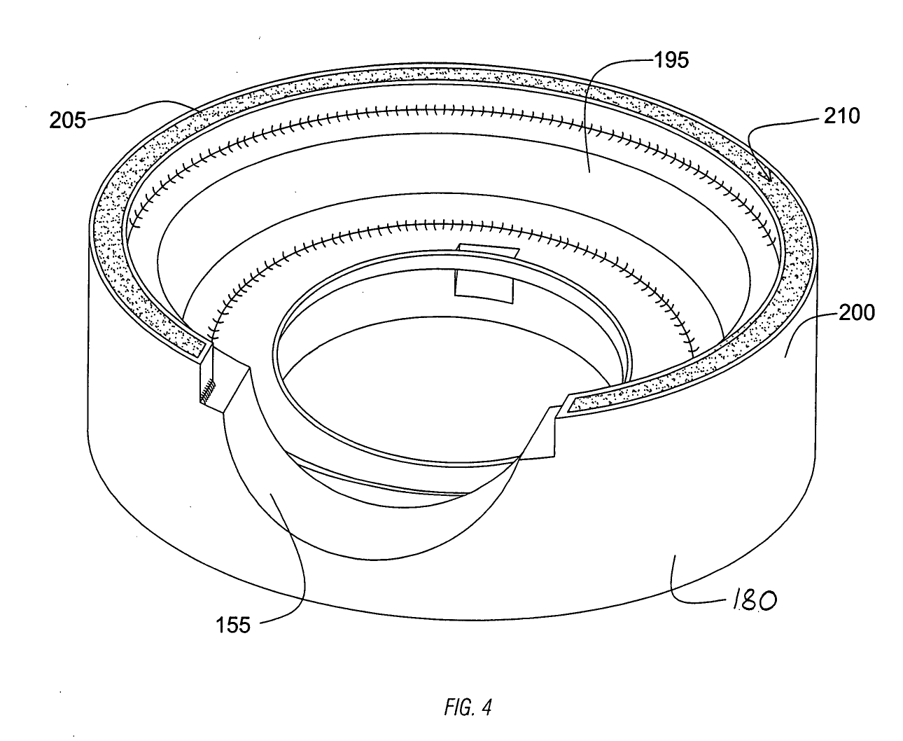

Turning to FIGS. 3 and 4, the insulation cartridge 90 is illustrated as including an exterior 145, an interior 150, an inlet 155, an outlet 160, and a turbine opening 165. The cartridge exterior 145 includes a cylindrical portion 170 that is centered on the rotational axis A-A (shown in FIG. 2). The inlet 155 passes through the cylindrical portion 170 at an angle that is approximately perpendicular to the rotational axis A-A to provide a flow path into the cartridge interior 150. The inlet 155 also provides space for the scroll inlet 95, which in turn receives the flow of products of combustion from the combustor 55.

The turbine opening 165 facilitates the attachment of the turbine rotor 60 to the compressor rotor 230. The insulation cartridge outlet 160 provides clearance space for the shroud/diffuser 70 and an expansion bellows 175 that guide the exhaust gas out of the turbine section 15.

To facilitate the assembly and manufacture of the engine 10 and the insulation cartridge 90, the insulation cartridge 90 is divided into two halves, an outlet half 180 and a turbine half 185. The outlet half 180 includes the outlet opening 160 and the turbine half 185 includes the turbine opening 165. The halves 180, 185 are separated along a plane that is substantially perpendicular to the rotational axis A-A and passes through the center of the inlet opening 155. The two halves 180, 185 each include an attachment flange 190 that allows for their attachment to one another. The attachment can be made using any common means, with bolts or welding being preferred. In some constructions, a slip joint exists between the halves 180, 185. The slip joint allows relative movement between the two halves 180, 185 during engine operation.

As illustrated in FIG. 4, the insulation cartridge 90 includes an inner wall 195, an outer wall 200, and a layer of insulating material 205 disposed between the inner wall 195 and the outer wall 200. The inner wall 195 attaches to the outer wall 200 to define a core space 210 that is substantially enclosed when the two halves 150, 155 of the insulation cartridge 90 are assembled. The layer of insulating material 205 is placed within the core space 210 to define a completed core. In most constructions, a ceramic material is used as insulating material 205. However other constructions may use other materials (e.g., trapped gas, plastic, glass, and the like). In still another construction, an evacuated space is used as the insulating material 205. While an outer wall 200 is illustrated herein, other constructions may eliminate the outer wall 200.

With continued reference to FIG. 2, the outer casing 80, or turbine housing is positioned outside of the insulation cartridge 90 and defines an inlet opening 215, an outlet opening 220, and a turbine opening 225. The turbine opening 225 provides for the coupling of the turbine rotor 60 to a compressor rotor 230 when the outer casing 80 is attached to a compressor casing 235. The inlet 215 is positioned to provide space for the passage of flow components that guide the flow of products of combustion from the combustor 55 to the turbine scroll 75. In some constructions, the recuperator 50 attaches directly to the outer casing 80 adjacent the inlet 215. In other constructions, an additional housing connects the outer casing 80 to the recuperator 50. A pipe or duct connects to the outer casing 80 adjacent the outlet 220 to receive the flow of exhaust gas exiting the shroud/diffuser 70 and direct that flow to the recuperator 50.

The walls that make up the outer casing 80 are generally thicker than the walls that make up the turbine scroll 75 and the insulation cartridge 90. In some constructions, the outer casing 80 may be cast from a lower-temperature alloy (e.g., low-alloy cast steel, cast iron, high-temperature cast iron, and the like) and then machined as required. In other constructions, the outer casing 80 is machined from a single piece of material, such as a forging. In many constructions, cast iron (e.g., NiResist Cast Iron) is the preferred material.

During engine operation the flow of products of combustion exits the combustor 55 and flows into the turbine scroll 75. A substantially sealed path between the combustor 55 and the turbine scroll 75 inhibits the entry of products of combustion into the inner gap 135 or the outer gap 140. From the turbine scroll 75, the flow of products of combustion passes through the remainder of the turbine section 15 as has been described. The products of combustion within the turbine scroll 75 have a temperature and a pressure. The temperature is quite high (e.g., 1400 degrees F. or higher), thus making the use of thin-walled high-temperature materials appropriate. However, the pressure within the turbine scroll 75 is also high (e.g., 2-30 times atmospheric pressure or higher). To reduce the pressure load on the scroll 75, recuperator discharge air is provided to the inner gap 135. Recuperator discharge air is preheated compressed air that has not been heated within the combustor 55. As such, recuperator discharge air has a lower temperature (e.g., about 1200 degrees F.) than the products of combustion. Furthermore, the pressure of the recuperator air is substantially equal to the pressure of the products of combustion. Thus, the pressure forces applied to the inside of the turbine scroll 75 are substantially equal to the pressure forces applied to the outside of the scroll 75. As such, a thick pressure-containing wall is not necessary for the turbine scroll 75.

The outer gap 140 is substantially sealed and provides little more than clearance between the outer casing 80 and the insulation cartridge 90. However, during engine operation, recuperator air typically leaks into the outer gap 140 and fills the space. Thus, the outer gap 140 is maintained at a pressure that is substantially equal to the pressure within the inner gap 135. However, because the outer gap 140 is substantially sealed, little flow between the inner gap 135 and the outer gap 140 will actually occur once the pressures equalize. As such, the gas trapped within the outer gap 140 will cool somewhat during engine operation. The substantially equal pressure within the inner gap 135 and outer gap 140 apply substantially equal pressure forces on either side of the insulation cartridge 90. As such, the overall pressure forces applied to the insulation cartridge 90 are small, thereby allowing for the use of thin-walled materials for its manufacture.

The insulation cartridge 90 does provide a significant thermal barrier between the products of combustion and the outer casing 80. As such, the outer casing 80 operates at a temperature that is lower than outer casings used in turbines that do not include an insulation cartridge 90. The lower temperature allows for the use of lower temperature materials to manufacture the casing 80. However, the pressure within the outer gap 140 is still approximately equal to the pressure of the flow of products of combustion. As such, the casing 80 must be strong enough to contain the forces generated by the difference in pressure between the interior of the casing 80 and the outer atmosphere. Typically, a thicker wall is used to provide the necessary strength. However, other constructions may employ higher-grade materials to achieve the desired strength. For example, one construction may substitute stainless steel for low-alloy steel to achieve the desired strength at the elevated operating temperature.

The strength of the casing 80 is a function of the thickness of the material, the operating temperature, and the particular material used. As such, different constructions may require different wall thicknesses. Generally, an outer casing 80 with a wall thickness of about one-half inch or more is well suited for use with the present invention. However, one of ordinary skill in the art will realize that thinner walls could be employed in constructions having suitable operating conditions, and thicker walls may be required under other conditions.

The insulation cartridge 90 functions to reduce the operating temperature of the outer casing 80. The lower operating temperature allows for the reduction in the wall thickness of the casing 80 and/or the reduction in the grade of material used to form the casing 80.

Although the invention has been described in detail with reference to certain preferred embodiments, variations and modifications exist within the scope and spirit of the invention as described and defined in the following claims.

1. A combustion turbine engine suited to operation in response to a flow of high-temperature gas, the combustion turbine engine comprising:
an outer housing including walls that define an inlet, an outlet, and an inner surface;
an insulation cartridge disposed within the outer housing and defining an inner space, the insulation cartridge including a wall and a core and operable to at least partially thermally insulate the outer housing from the flow of high-temperature gas; and
a turbine rotor disposed substantially within the inner space and rotatable in response to the flow of high-temperature gas.

2. The turbine of claim 1, wherein the outer housing includes walls having an average thickness of at least one-half inch.

3. The turbine of claim 1, wherein the outer housing includes a cast portion.

4. The turbine of claim 1, wherein the outer housing includes cast iron.

5. The turbine of claim 1, wherein the outer housing includes cast steel.

6. The turbine of claim 1, wherein the core of the insulation cartridge includes a ceramic insulating material.

7. The turbine of claim 1, wherein the wall of the insulation cartridge has an average thickness of less than about 0.150 inches.

8. The turbine of claim 1, wherein the wall of the insulation cartridge includes an alloy steel.

9. The turbine of claim 1, wherein the wall of the insulation cartridge substantially encapsulates the core.

10. The turbine of claim 1, wherein the core includes a layer of insulation that is at least about one-half inch thick.

11. A microturbine engine system operable to provide electrical power, the microturbine engine system comprising:
a compressor operable to produce a flow of compressed air;
a recuperator in fluid communication with the compressor to receive the flow of compressed air, the flow of compressed air being preheated within the recuperator to produce a flow of preheated compressed air;
a combustor receiving the flow of preheated compressed air and operable to produce a flow of products of combustion, the flow of products of combustion having a temperature that generates thermal forces and a pressure that generates pressure forces;
a turbine driven by the flow of products of combustion, the turbine discharging the flow of products of combustion to the recuperator to preheat the flow of compressed air;
a housing at least partially enclosing the turbine and including an inner surface;
an insulation cartridge positioned within the housing, the insulation cartridge at least partially isolating the housing from the flow of products of combustion such that the housing absorbs a majority of the pressure forces and the insulation cartridge absorbs a majority of the thermal forces; and
a generator coupled to the turbine, the generator driven by the turbine at a speed to output electrical power.

12. The turbine of claim 11, wherein the housing includes walls having an average thickness of at least one-half inch.

13. The turbine of claim 11, wherein the housing includes cast iron.

14. The turbine of claim 11, wherein the housing includes cast steel.

15. The turbine of claim 11, wherein the insulation cartridge includes a ceramic insulating material.

16. The turbine of claim 15, wherein the insulation cartridge substantially encapsulates the insulation.

17. The turbine of claim 15, wherein the insulation is at least about one-half inch thick.

18. The turbine of claim 11, wherein the insulation cartridge includes a wall that includes an alloy steel.

19. The turbine of claim 17, wherein the wall has an average thickness of less than about 0.150 inches.

20. A method of assembling a turbine for use in a combustion turbine engine, the method comprising:
providing a housing including an inlet, an outlet, and an inner surface;
forming an insulation cartridge having a wall that defines a core space;
positioning an insulating material within the core space;
inserting the insulation cartridge into the turbine casing; and
supporting a rotor for rotation within the housing.

21. The method of claim 20, wherein the providing step includes casting at least a portion of the housing using a cast iron material.

22. The method of claim 20, wherein the insulating material includes a ceramic material.
